(19) United States
(12) Patent Application Publication
(10) Pub. No.: US 2005/0047785 A1
(43) Pub. Date: Mar. 3, 2005

(54) Bi-directional wavelength division multiplexing passive optical network and method for allocating wavelength band

(76) Inventors: Seong-Taek Hwang, Pyeongtaek-si (KR); Dae-Kwang Jung, Suwon-si (KR); Hoon Kim, Suwon-si (KR); Yun-Je Oh, Yongin-si (KR); Chang-Sup Shim, Seoul (KR)

Correspondence Address: CHA & REITER, LLC, 210 ROUTE 4 EAST STE 103, PARAMUS, NJ, 07652, US

(21) Appl. No.: 10/818,194

(22) Filed: Apr. 5, 2004

(30) Foreign Application Priority Data
Sep. 1, 2003 (KR) 2003-60712

(51) Int. Cl. H04J 14/00

(52) U.S. Cl. 398/72

(57) ABSTRACT

A bi-directional WDM-PON and a method for allocating a wavelength band are disclosed. In the bi-directional WDM-PON, bi-directional transceiver modules are used to transmit optical signals of different wavelengths in the upstream and downstream directions. An L-band and an S-band are used to allocate wavelength bands to the upstream and downstream optical signals so that a wavelength band interval at which the respective wavelength bands of the upstream and downstream optical signals are spaced is set between 50 nm to 150 nm.

### CLAIM OF PRIORITY

This application claims priority to an application entitled “BI-DIRECTIONAL WAVELENGTH DIVISION MULTIPLEXING PASSIVE OPTICAL NETWORK AND METHOD FOR ALLOCATING WAVELENGTH BAND IN THE SAME,” filed in the Korean Intellectual Property Office on Sep. 1, 2003 and assigned Serial No. 2003-60712, the contents of which are hereby incorporated by reference.

### BACKGROUND OF THE INVENTION

1. Field of the Invention

The present invention relates to a bi-directional WDM-PON (Wavelength Division Multiplexing-Passive Optical Network), and more particularly to a system and method for effectively allocating a wavelength band in a WDM-PON using a bi-directional transceiver module.

2. Description of the Related Art

Conventional WDM-PONs provide broadband communication services using unique wavelengths assigned respectively to subscribers. The WDM-PON can accommodate a separate communication service or communication-capacity extension requested by each subscriber. In addition, the number of subscribers can be increased by adding unique wavelengths that are assigned to new subscribers. Despite these advantages, the WDM-PON has not yet been put to practical use because it not economical for subscribers because of the need to provide a central office (CO), a light source of a specific lasing or oscillation wavelength for each subscriber, and an additional wavelength-stabilization circuit for stabilizing the wavelength of the light source.

One attempt to address this problem has been a WDM-PON uses, as the WDM light source, a distributed feedback (DFB) laser array, a multi-frequency laser (MFL), a picosecond pulse light source or the like. However, the DFB laser array and the MFL have a complicated manufacturing process, and are high-priced elements which require wavelength stabilization and accurate wavelength selection of the light source in order to implement the wavelength division multiplexing.

Another attempt to address this problem is a WDM-PON that uses, as the WDM light source, a spectrum-sliced light source, a mode-locked light source with incoherent light, and a wavelength-seeded reflective semiconductor optical amplifier that do not require wavelength stabilization and wavelength selection. However, researchers are still trying to realize an economical and useable network with such light source.

### SUMMARY OF THE INVENTION

One aspect of the present invention is to provide a bi-directional WDM-PON (Wavelength Division Multiplexing-Passive Optical Network) that can realize an economical network by using a single bi-directional transceiver module.

It is another aspect of the present invention to provide a method for allocating wavelength bands in a bi-directional WDM-PON.

One embodiment of the present invention is directed to a WDM-PON (Wavelength Division Multiplexing-Passive Optical Network) including a central office including N first bi-directional transceiver modules for providing downstream optical signals and detecting upstream optical signals, and a first multiplexer/demultiplexer for multiplexing/demultiplexing upstream/downstream optical signals, and N subscriber devices. Each subscriber device is connected with the local office with a single optical transmission line. The N subscriber devices include N second bi-directional transceiver modules for providing upstream optical signals and detecting downstream optical signals, respectively; and a local office connected with the central office through a single optical transmission line. The local office includes a second multiplexer/demultiplexer for multiplexing/demultiplexing upstream/downstream optical signals transmitted from the central office and the subscriber devices.

Another embodiment of the present invention is directed to a method for allocating wavelength bands in a bi-directional WDM-PON that employs bi-directional transceiver modules to transmit optical signals of different wavelengths in upstream and downstream directions. A wavelength band interval at which respective wavelength bands of the upstream and downstream optical signals are spaced is set between 50 nm to 150 nm.

In one embodiment, a 1.3 μm wavelength band of 1300 nm to 1350 nm and an S-band of 1450 nm to 1500 nm are allocated to the upstream optical signals and the downstream optical signals, respectively, and alternately an S-band of 1450 nm to 1500 nm and a 1.3 μm wavelength band of 1300 nm to 1350 nm are allocated to the upstream optical signals and the downstream optical signals, respectively. An L-band of 1560 nm to 1620 nm and an S-band of 1450 nm to 1500 nm may be allocated to the upstream optical signals and the downstream optical signals, respectively, and alternately an S-band of 1450 nm to 1500 nm and an L-band of 1560 nm to 1620 nm may be allocated to the upstream optical signals and the downstream optical signals, respectively.

### BRIEF DESCRIPTION OF THE DRAWINGS

The above and other aspects, features and other embodiments of the present invention will be more clearly understood from the following detailed description taken in conjunction with the accompanying drawings, in which:

FIG. 1 shows the configuration of a bidirectional WDM-PON according to a first embodiment of the present invention;

FIG. 2 shows an example of the configuration of a TO-can type bi-directional transceiver applied to the WDM-PON of FIG. 1; and

FIG. 3 shows the configuration of a bi-directional WDM-PON according to a second embodiment of the present invention.

### DETAILED DESCRIPTION

Now, embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted when it may obscure the subject matter of the present invention.

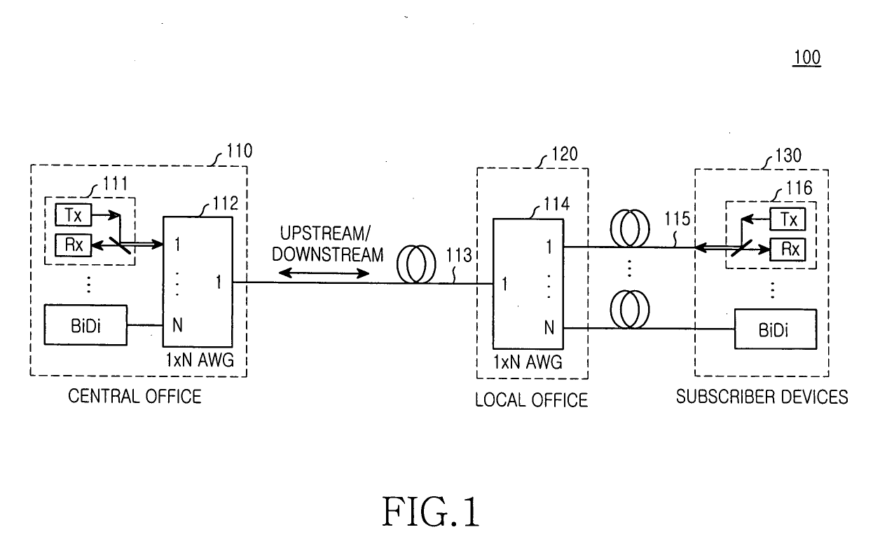

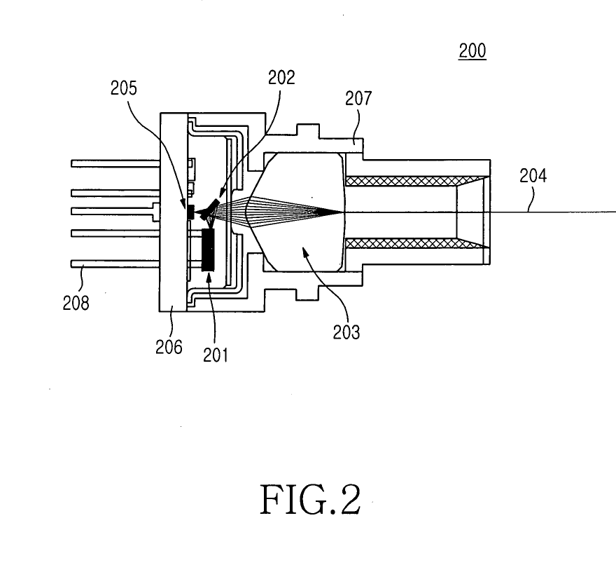

FIG. 1 shows the configuration of a bi-directional WDM-PON according to a first embodiment of the present invention. FIG. 2 shows an example of the configuration of a TO-can type bi-directional transceiver applied to the WDM-PON shown in FIG. 1.

As shown in FIG. 1, the bi-directional WDM-PON 100 includes a central office 110, a local office 120 connected with the central office 110 through a single optical fiber 113, and a plurality of subscriber devices 130 (N subscriber devices 130 in this example). Each subscriber is connected with the local office 120 through a single optical fiber 115.

The central office 110 includes N bi-directional transceiver modules (BiDi) 111 for simultaneously transmitting and receiving optical signals of different wavelengths, and a 1×N arrayed waveguide grating (1×N AWG) 112 for multiplexing/demultiplexing the optical signals.

The local office 120 includes a 1×N arrayed waveguide grating (1×N AWG) 114, which demultiplexes a downstream optical signal received from the central office 110 through the single optical fiber 113, multiplexes N upstream optical signals transmitted from the N subscriber devices via the N single optical fibers 115, respectively, and outputs the demultiplexed and multiplexed optical signals.

The N subscriber devices 130 include N bidirectional transceiver modules 116 that can simultaneously transmit and receive optical signals of N different wavelengths, respectively.

FIG. 2 shows a TO-can type bi-directional transceiver module (BiDi) 200, that may be provided in each of the central office 110 and the subscriber devices 130. As shown in this figure, an optical signal output from a transmitter (LD) 201 in the module 200 is reflected by a surface of an optical filter 202. A lens 203 then focuses the reflected signal so that it is transmitted through an optical fiber 204. An optical signal received through the optical fiber 204 is focused by the lens 203, and the focused optical signal passes through the optical filter 202 to reach a receiver (PD) 205. Reference numeral 206 in FIG. 2 denotes a stem, 207 denotes a module housing, and 208 denotes a lead line.

Now, the operation of the bi-directional WDM-PON 100 configured as described above will be described with reference to FIGS. 1 and 2.

First, in the case of downstream transmission, optical signals of different wavelengths are output respectively from the N bidirectional transceiver modules 111 located in the central office 110. The 1×N arrayed waveguide grating (AWG) 112 multiplexes the output optical signals into a downstream optical signal. This signal is then transmitted to the local office 120 through the single optical fiber 113. The 1×N AWG 114 demultiplexes the downstream optical signal into a plurality of downstream optical signals, which are then transmitted to the N subscriber devices 130 through the N optical fibers 115, respectively. The bi-directional transceiver modules 116 detect the downstream optical signals as electrical signals.

Likewise, in the case of upstream transmission, N optical signals of different wavelengths are output respectively from the N bi-directional transceiver modules 116 and transmitted to the local office 120 via the N optical fibers 115, respectively. The 1×N AWG 114 multiplexes the optical signals into an upstream optical signal, which is then transmitted to the central office 110 through the single optical fiber 113. The 1×N AWG 112 then demultiplexes the upstream optical signal into upstream optical signals. The N bi-directional transceiver modules 111 detect them as electrical signals.

Since it is small in size, the TO-can type bi-directional transceiver module has limitations on the locations of the transmitter L D, the receiver PD and the optical filter. The respective wavelength bands of the input and output optical signals should be spaced at least 50 nm (a predetermined wavelength band interval) apart. This makes it difficult to use a wavelength band between 1530 nm and 1560 nm and a wavelength band between 1570 nm and 1600 nm (for example, for upstream and downstream optical signals, respectively), since the wavelength band interval is about 10 nm (i.e., less than the predetermined wavelength band interval of 50 nm). Accordingly, a 1.3 μm wavelength band (1300 nm ˜1350 nm) and a 1.5 μm wavelength band (1520 nm ˜1620 nm) are generally used for upstream and downstream signals.

However, if the upstream and downstream wavelength intervals are large, the insertion losses of optical elements such as optical fibers and 1×N AWGs are large. In addition, the bandwidths of the 1×N AWGs and differences in the dispersion of the optical fiber are also large. These must be taken into careful consideration when the system is designed. Accordingly, in this embodiment of the present invention, a wavelength band interval at which the respective wavelength bands of the upstream and downstream optical signals are spaced is set between 50 nm to 150 nm. For example, a 1.3 μm wavelength band (1300 nm ˜1350 nm) is allocated to upstream optical signals while an S-band (1450 nm ˜1500 nm) is allocated to downstream optical signals, or conversely an S-band (1450 nm ˜1500 nm) is allocated to upstream optical signals while a 1.3 μm wavelength band (1300 nm˜1350 nm) is allocated to downstream optical signals. Alternatively, an L-band (1560 nm ˜1620 nm) is allocated to upstream optical signals while an S-band (1450 nm ˜1500 nm) is allocated to downstream optical signals, or conversely an S-band (1450 nm ˜1500 nm) is allocated to upstream optical signals while an L-band (1560 nm ˜1620 nm) is allocated to downstream optical signals. These efficient allocations of upstream and downstream wavelength bands make it possible to accommodate a wide range of the existing bi-directional transceiver modules.

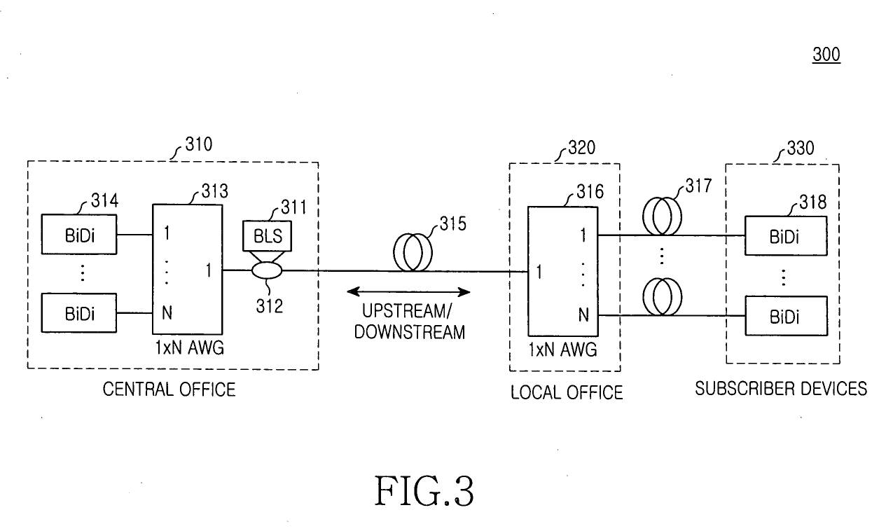

FIG. 3 shows the configuration of a bi-directional WDM-PON according to a second embodiment of the present invention.

As shown in this figure, the bi-directional WDM-PON 300 includes a central office 310, a local office 320 connected with the central office 310 through a single optical fiber 315, and a plurality of subscriber devices 330 (in this example, N subscriber devices 330). Each subscriber is connected with the local office 320 through a single optical fiber 317.

The central office 310 includes a broadband light source (BLS) 311 for generating a broadband signal, a 2×2 optical splitter 312, a 1×N arrayed waveguide grating (1×N AWG) 313, and N bi-directional transceiver modules (BiDi) 314. The local office 320 includes a 1×N AWG 316. The subscriber devices include N bi-directional transceiver modules 318, respectively.

Now, the operation of the bi-directional WDM-PON 300 configured as described above will be described with reference to FIG. 3.

First, in the case of downstream transmission, a broadband signal is generated from the broadband light source 311 located in the central office 310. After it is input to the 1×N AWG 313 through the 2×2 optical splitter 312, the broadband signal is spectrum-sliced into N channels. Each spectrum-sliced channel is injected into a corresponding downstream wavelength-injected light source (for example, a mode-locked Fabry-Perot laser with incoherent light or a wavelength-seeded reflective semiconductor optical amplifier), which is provided in each single bidirectional transceiver module 314. The downstream wavelength-injected light source outputs an optical signal that has the same wavelength as that of a spectrum-sliced channel injected into the light source, and is directly modulated based on downstream data to be transmitted. The downstream optical signals output from the transceiver modules 314 are input to the 1×N AWG 313, which multiplexes them into a downstream optical signal. After passing through the 2×2 optical splitter 312, the multiplexed downstream optical signal is transmitted to the local office 320 through the single optical fiber 315. The 1×N AWG 316 in the local office 320 demultiplexes the downstream optical signal into N downstream optical signals, which are then transmitted to the N subscriber devices 330 through the N optical fibers 317, respectively. Each downstream optical signal is input to a receiver PD in a bi-directional transceiver module 318 in the corresponding subscriber device 330. The receiver PD detects the input downstream optical signal as an electrical signal.

Likewise, in the case of upstream transmission, a broadband signal is generated from the broadband light source 311 in the central office 310. After it is input to the 1×N AWG 316 through the 2×2 optical splitter 312, the broadband signal is spectrum-sliced into N channels. Each spectrum-sliced channel is injected into an upstream wavelength-injected light source (LD) in the bi-directional transceiver module 318 of the corresponding subscriber devices 330. The upstream wavelength-injected light source outputs an optical signal that has the same wavelength as that of a spectrum-sliced channel injected into the light source, and is directly modulated based on upstream data to be transmitted. The N upstream optical signals output from the transceiver modules 318 are input to the 1×N AWG 316 in the local office 320 via the N optical fibers 317, respectively, and the 1×N AWG 316 multiplexes them into an upstream optical signal. The multiplexed upstream optical signal is transmitted to the central office 310 through the single optical fiber 315. After passing through the 2×2 optical splitter 312, the upstream optical signal is demultiplexed into N signals at the 1×N AWG 313. Each demultiplexed signal is input to a receiver PD in the corresponding bi-directional transceiver module 314, and the receiver PD detects the input signal as an electrical signal.

In this embodiment, a 1.3 μm wavelength band (1300 nm ˜1350 nm) is allocated to upstream optical signals while an S-band (1450 nm ˜1500 nm) is allocated to downstream optical signals, or conversely an S-band (1450 nm ˜1500 nm) is allocated to upstream optical signals while a 1.3 μm wavelength band (1300 nm ˜1350 nm) is allocated to downstream optical signals. Alternatively, an L-band (1560 nm ˜1620 nm) is allocated to upstream optical signals while an S-band (1450 nm ˜1500 nm) is allocated to downstream optical signals, or conversely an S-band (1450 nm ˜1500 nm) is allocated to upstream optical signals while an L-band (1560 nm ˜1620 nm) is allocated to downstream optical signals. These efficient allocations of upstream and downstream wavelength bands make it possible to accommodate a wide range of the existing bi-directional transceiver modules.

The method for allocating wavelength bands according to aspects of the present invention may be applied not only to the bi-directional WDM-PON employing the single optical fiber but also to a bi-directional WDM-PON employing two or more optical fibers.

As apparent from the above description, according to embodiments of the present invention, bi-directional transceiver modules and a single arrayed waveguide grating (AWG) provided in each of central and local offices may be used to simultaneously multiplex/demultiplex upstream and downstream transmission optical signals in a bi-directional WDM-PON. This make it possible to reduce the number of AWGs and the number of optical transceiver elements used in the bi-directional WDM-PON.

In addition, according to embodiments of the present invention, wavelength bands may be allocated to upstream and downstream signals in a bi-directional WDM-PON system to reduce degradation of the optical communication system due to insertion losses in optical elements such as AWGs, differences in the dispersion characteristics of the optical fibers and the bandwidths of the AWGs.

Although the above embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to the above embodiments, but defined by the accompanying claims as well as equivalents thereof.

1. A WDM-PON (Wavelength Division Multiplexing-Passive Optical Network) comprising:
a central office including a plurality of first bi-directional transceiver modules arranged to provide downstream optical signals and detect upstream optical signals, and a first multiplexer/demultiplexer for multiplexing/demultiplexing upstream/downstream optical signals;
a plurality of subscriber devices including second bidirectional transceiver modules, respectively, arranged to provide upstream optical signals and detect downstream optical signals; and
a local office communicatively connected to the central office through an optical transmission line, said local office including a second multiplexer/demultiplexer for multiplexing/demultiplexing upstream/downstream optical signals transmitted from the central office and said plurality of subscriber devices,
wherein said plurality of subscriber devices are communicatively connected with the local office with an optical transmission line.

2. The WDM-PON according to claim 1, further comprising:
a broadband light source, arranged to provide a broadband signal to a light source, provided in each of said first and second bi-directional transceiver modules; and
an optical splitter arranged to inject the broadband signal into the first and second multiplexers/demultiplexers.

3. The WDM-PON according to claim 2, wherein said light source includes a mode-locked Fabry-Perot laser with incoherent light.

4. The WDM-PON according to claim 2, wherein said light source includes a wavelength-seeded reflective semiconductor optical amplifier.

5. The WDM-PON according to claim 1, wherein each of said first and second multiplexers/demultiplexers includes an arrayed waveguide grating.

6. The WDM-PON according to claim 1, wherein each of said plurality of first bi-directional transceiver modules and said plurality of second bi-directional transceiver modules includes a TO-can type bi-directional transceiver module.

7. The WDM-PON according to claim 1, wherein a 1.3 μm wavelength band of 1300 nm to 1350 nm and a 1.5 μm wavelength band of 1520 nm to 1620 nm are allocated to the upstream optical signals and the downstream optical signals, respectively, and alternately a 1.5 μm wavelength band of 1520 nm to 1620 nm and a 1.3 μm wavelength band of 1300 nm to 1350 nm are allocated to the upstream optical signals and the downstream optical signals, respectively.

8. The WDM-PON according to claim 1, wherein a 1.3 μm wavelength band of 1300 nm to 1350 nm and an S-band of 1450 nm to 1500 nm are allocated to the upstream optical signals and the downstream optical signals, respectively, and alternately an S-band of 1450 nm to 1500 nm and a 1.3 μm wavelength band of 1300 nm to 1350 nm are allocated to the upstream optical signals and the downstream optical signals, respectively.

9. The WDM-PON according to claim 1, wherein an L-band of 1560 nm to 1620 nm and an S-band of 1450 nm to 1500 nm are allocated to the upstream optical signals and the downstream optical signals, respectively, and alternately an S-band of 1450 nm to 1500 nm and an L-band of 1560 nm to 1620 nm are allocated to the upstream optical signals and the downstream optical signals, respectively.

10. The WDM-PON according to claim 1, wherein an L-band of 1560 nm to 1620 nm and a 1.3 μm wavelength band of 1300 nm to 1350 nm are allocated to the upstream optical signals and the downstream optical signals, respectively, and alternately a 1.3 μm wavelength band of 1300 nm to 1350 nm and an L-band of 1560 nm to 1620 nm are allocated to the upstream optical signals and the downstream optical signals, respectively.

11. A method for allocating wavelength bands in a bi-directional WDM-PON, comprising the steps of:
transmitting optical signals of different wavelengths in upstream and downstream directions using bi-directional transceiver modules; and
setting a wavelength band interval at which respective wavelength bands of the upstream and downstream optical signals are spaced between 50 nm to 150 nm.

12. The method according to claim 11, further comprising the step of:
allocating a 1.3 μm wavelength band of 1300 nm to 1350 nm and an S-band of 1450 nm to 1500 nm to the upstream optical signals and the downstream optical signals, respectively.

13. The method according to claim 11, further comprising the step of:
allocating an S-band of 1450 nm to 1500 nm and a 1.3 μm wavelength band of 1300 nm to 1350 nm to the upstream optical signals and the downstream optical signals, respectively.

14. The method according to claim 11, further comprising the step of:
allocating an L-band of 1560 nm to 1620 nm and an S-band of 1450 nm to 1500 nm to the upstream optical signals and the downstream optical signals, respectively.

15. The method according to claim 11, further comprising the step of:
allocating an S-band of 1450 nm to 1500 nm and an L-band of 1560 nm to 1620 nm to the upstream optical signals and the downstream optical signals, respectively.

16. A WDM-PON (Wavelength Division Multiplexing-Passive Optical Network) comprising:
a plurality of first bi-directional transceiver modules arranged to provide downstream optical signals and detect upstream optical signals, and a first multiplexer/demultiplexer for multiplexing/demultiplexing upstream/downstream optical signals;
at least two subscriber devices including second bi-directional transceiver modules, respectively, arranged to provide upstream optical signals and detect downstream optical signals; and
a second multiplexer/demultiplexer for multiplexing/demultiplexing upstream/downstream optical signals transmitted from said first bidirectional transceiver module and said at least two subscriber devices.

17. The WDM-PON according to claim 16, further comprising:
a broadband light source, arranged to provide a broadband signal to a light source, provided in each of said first and second bi-directional transceiver modules; and
an optical splitter arranged to inject the broadband signal into the first and second multiplexers/demultiplexers.

18. The WDM-PON according to claim 16, wherein a 1.3 μm wavelength band of 1300 nm to 1350 nm and a 1.5 μm wavelength band of 1520 nm to 1620 nm are allocated to the upstream optical signals and the downstream optical signals, respectively, and alternately a 1.5 μm wavelength band of 1520 nm to 1620 nm and a 1.3 μm wavelength band of 1300 nm to 1350 nm are allocated to the upstream optical signals and the downstream optical signals, respectively.

19. The WDM-PON according to claim 16, wherein a 1.3 μm wavelength band of 1300 nm to 1350 nm and an S-band of 1450 nm to 1500 nm are allocated to the upstream optical signals and the downstream optical signals, respectively, and alternately an S-band of 1450 nm to 1500 nm and a 1.3 μm wavelength band of 1300 nm to 1350 nm are allocated to the upstream optical signals and the downstream optical signals, respectively.

20. The WDM-PON according to claim 16, wherein an L-band of 1560 nm to 1620 nm and an S-band of 1450 nm to 1500 nm are allocated to the upstream optical signals and the downstream optical signals, respectively, and alternately an S-band of 1450 nm to 1500 nm and an L-band of 1560 nm to 1620 nm are allocated to the upstream optical signals and the downstream optical signals, respectively.

21. The WDM-PON according to claim 16, wherein an L-band of 1560 nm to 1620 nm and a 1.3 μm wavelength band of 1300 nm to 1350 nm are allocated to the upstream optical signals and the downstream optical signals, respectively, and alternately a 1.3 μm wavelength band of 1300 nm to 1350 nm and an L-band of 1560 nm to 1620 nm are allocated to the upstream optical signals and the downstream optical signals, respectively.
